(19) United States
(12) Patent Application Publication
(10) Pub. No.: US 2025/0374356 A1
(43) Pub. Date: Dec. 4, 2025

(54) METHOD FOR CONNECTING DEVICES AND SYSTEM

(71) Applicant: Lenovo (Beijing) Limited, Beijing (CN)

(72) Inventors: Yiming ZHU, Beijing (CN); Changfu LI, Beijing (CN)

(21) Appl. No.: 19/217,445

(22) Filed: May 23, 2025

(30) Foreign Application Priority Data
May 28, 2024 (CN) 202410670227.0

(51) Int. Cl. H04W 76/15; H04L 9/08; H04W 4/80; H04W 76/30

(52) U.S. Cl. CPC H04W 76/15; H04L 9/0819; H04W 4/80; H04W 76/30

(57) ABSTRACT

A method for connecting devices, applied to a first device, includes receiving a first signal sent by a second device via a first channel, wherein the first signal is generated by the second device based on a touch input operation of the first device, determining that the first signal includes first indication information, and prohibiting broadcasting a second channel connection initiation signal, wherein the first indication information indicates that the first device previously established a second channel connection with the second device, and establishing a second channel connection with the second device based on a stored locally encryption key, wherein the encryption key was received by the first device from the second device when the first device previously established the second channel connection with the second device, and the first channel and a second channel have different transmission protocols.

### CROSS-REFERENCE TO RELATED APPLICATION

The present disclosure claims priority to Chinese Patent Application No. 202410670227.0, filed on May 28, 2024, the entire content of which is incorporated herein by reference.

### TECHNICAL FIELD

The present disclosure is related to the information processing technology field and, more particularly, to a method for connecting devices and a device connection system.

### BACKGROUND

Currently, short-range wireless communication technology has been widely used in various electronic devices. In a fast pairing process, an input device is triggered by a masking coded signal of a touch device to broadcast to realize fast pairing.

However, each time the input device contacts the touch device to perform a touch input operation, the touch device generates a mask signal and sends the mask signal to the input device. The mask signal generated each time by the contact triggers the input device to broadcast signals for fast pairing, which causes high power consumption for the input device.

### SUMMARY

An aspect of the present disclosure provides a method for connecting devices, applied to a first device. The method includes receiving a first signal sent by a second device via a first channel, wherein the first signal is generated by the second device based on a touch input operation of the first device, determining that the first signal includes first indication information, and prohibiting broadcasting a second channel connection initiation signal, wherein the first indication information indicates that the first device previously established a second channel connection with the second device, and establishing a second channel connection with the second device based on a stored locally encryption key, wherein the encryption key was received by the first device from the second device when the first device previously established the second channel connection with the second device, and the first channel and a second channel have different transmission protocols.

An aspect of the present disclosure provides a method for connecting devices, applied to a second device. The method includes generating a first signal according to first indication information based on a touch input operation received from a first device, wherein the first indication information indicates that the first device previously established a second channel connection with the second device, transmitting the first signal to the first device via a first channel to allow the first device to prohibit broadcasting a second channel connection initiation signal based on the first indication information in the first signal, receiving connection request information of establishing the second channel connection sent by the first device, and establishing the second channel connection with the first device based on the connection request information. The connection request information is generated by the first device based on a locally stored encryption key, and the first channel and a second channel have different transmission protocols.

An aspect of the present disclosure provides a device connection system, including a first device and a second device. The first device includes a processor and a signal receiver. The second device includes a touch screen and a signal transmitter. In response to the touch screen of the second device receiving a touch input operation from the first device, a first signal is generated based on first indication information, the first indication information indicates that the first device previously established a second channel connection with the second device, and the signal transmitter transmits the first signal to the first device via a first channel. The signal receiver of the first device receives the first signal, the processor of the first device determines that the first signal includes the first indication information, prohibits broadcasting a second channel connection initiation signal, and establishes the second channel connection with the second device based on a locally stored encryption key, the encryption key was received by the first device from the second device when the first device previously established the second channel connection with the second device, and the first channel and a second channel have different transmission protocols.

### BRIEF DESCRIPTION OF THE DRAWINGS

FIG. 1 illustrates a schematic flowchart of a method for connecting devices according to some embodiments of the present disclosure.

FIG. 2 illustrates a schematic flowchart of a first signal including second indication information according to some embodiments of the present disclosure.

FIG. 3 illustrates a schematic diagram showing an application scenario of a method for connecting devices according to some embodiments of the present disclosure.

FIG. 4 illustrates a schematic flowchart of a first device and a second device agreeing on first indication information according to some embodiments of the present disclosure.

FIG. 5 illustrates a schematic diagram of a correspondence according to some embodiments of the present disclosure.

FIG. 6 illustrates a schematic flowchart of assigning first indication information to a second device based on a predetermined indication information assignment rule according to some embodiments of the present disclosure.

FIG. 7 illustrates a schematic flowchart of determining whether a first signal includes first indication information according to some embodiments of the present disclosure.

FIG. 8 illustrates a schematic flowchart of another method for connecting devices according to some embodiments of the present disclosure.

FIG. 9 illustrates a schematic structural diagram of a device connection system according to some embodiments of the present disclosure.

### DETAILED DESCRIPTION OF THE EMBODIMENTS

The technical solutions of embodiments of the present disclosure are described in detail below in conjunction with the accompanying drawings of embodiments of the present disclosure. Apparently, the embodiments described are only some embodiments of the present disclosure, not all embodiments. Based on embodiments of the present disclosure, all other embodiments obtained by those of ordinary skill in the art without creative efforts shall be within the scope of the present disclosure.

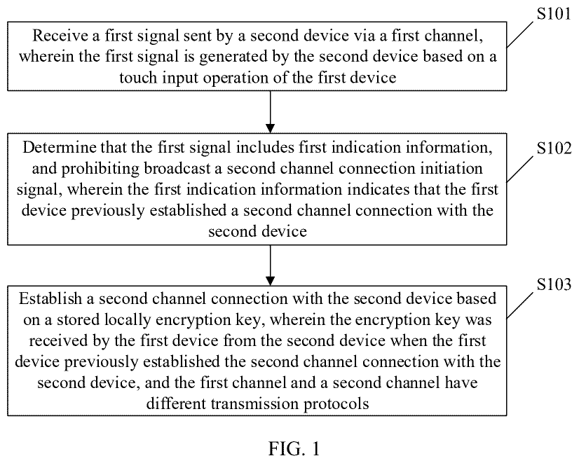

FIG. 1 illustrates a schematic flowchart of a method for connecting devices according to some embodiments of the present disclosure. The method can be applied to an electronic device. The device can be used as the first device. The first device can be configured to perform a touch input operation on a second device. The method includes the following steps.

At S101, a first signal sent by the second device based on a first channel is received. The first signal is a signal generated by the second device based on a touch input operation of the first device.

The first device executing a method for connecting devices of embodiments of the present disclosure can be configured to perform the touch input operation on the second device. The second device can receive and respond to the touch operation.

In some embodiments, the first device can be a stylus, and the second device can be a touchpad.

When the first device performs the touch input operation on a touch input area of the second device, the second device can generate the first signal and send the first signal to the first device.

In some embodiments, the first signal can be a mask signal. The first channel can be a mask signal transmission channel configured to transmit the mask signal.

In some embodiments, the first signal can be an uplink mask signal. The first channel can be a mask signal transmission channel configured to transmit the mask signal between the first device and the second device. The first channel can also be configured to transmit the mask signal sent by the first device to the second device. To distinguish between mask signals sent by different devices, the mask signal sent by the second device to the first device can be referred to as an uplink mask signal, and the mask signal sent by the first device to the second device can be referred to as a downlink mask signal. In some embodiments, in response to a second signal (e.g., a downlink mask signal) sent by the first device to the second device, the second device can send the first signal (e.g., an uplink mask signal) to the first device.

At S102, the first signal is determined to include first indication information, and broadcasting of a second channel connection initiation signal is prohibited. The first indication information indicates that the first device has previously established a second channel connection with the second device.

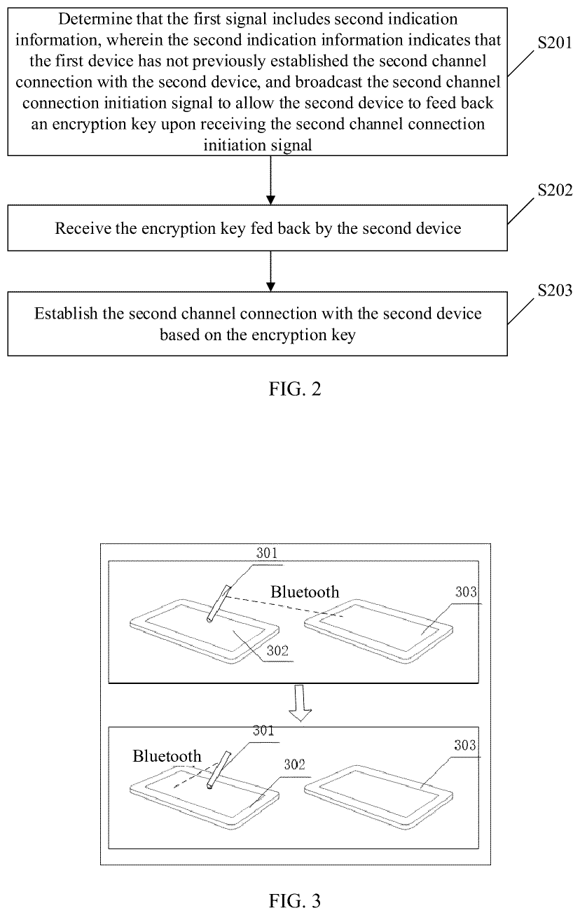

The first signal can include at least indication information. The indication information can include first indication information, second indication information, etc. The first indication information can indicate that the first device has previously established a second channel connection with the second device. The second indication information can indicate that the first device has not established the second channel connection with the second device. The first signal processing process including the second indication information is described subsequently in FIG. 2.

The second device can be configured to transmit the first signal to the first device through the first channel. The first device can be configured to analyze the first signal to obtain the indication information carried by the first signal.

If the first signal includes the first indication information, the first device can be determined to have previously established the second channel connection with the second device.

The second channel can adopt a transmission protocol different from a transmission protocol of the first channel.

The second channel can adopt a Bluetooth transmission protocol or a WiFi (Wireless Fidelity) transmission protocol.

The first device can establish an initial connection with the second device by broadcasting the second channel connection initiation signal.

If the received first signal includes the first indication information, the first device can be determined to have previously established a second channel connection with the second device. Then, a connection method different from the initial connection can be performed. To reduce the power consumption of the first device for broadcasting signals, the first device can prohibit broadcasting the second channel connection initiation signal.

For example, the first device can be a stylus equipped with Bluetooth, and the second device can be a tablet computer equipped with Bluetooth. When the stylus contacts the touchscreen of the tablet computer, the tablet computer can send an uplink mask signal to the stylus through the mask signal transmission channel. The stylus can determine whether the stylus has previously established a Bluetooth connection with the tablet computer based on the indication information in the uplink mask signal.

In some embodiments, whether the first signal includes the first indication information can be determined according to the correspondence between the indication information and the devices stored in the first device. FIG. 7 illustrates a schematic flowchart of determining whether a first signal includes first indication information according to some embodiments of the present disclosure.

At S103, a second channel connection is established with the second device based on a locally stored encryption key. The encryption key was received by the first device from the second device when the first device previously established the second channel connection with the second device. The transmission protocol of the second channel is different from the transmission protocol of the first channel.

When the first device previously established the second channel connection with the second device to complete the pairing process, the second device and the first device can exchange the encryption keys to ensure data transmission security. After successfully being paired, the first device and the second device can perform normal data transmission.

Moreover, after the first device and the second device previously established the second channel connection, the first device saved the encryption key sent by the second device to provide the foundation for subsequent fast pairing.

Once the first device is determined to have previously established a second channel connection with the second device, and this connection is a reconnection process, the first device can establish the second channel connection directly with the second device based on the locally stored encryption key without obtaining the encryption key again from the second device. Thus, the process of exchanging the encryption keys with the second device can be reduced, the connection efficiency can be improved, and the power consumption of the first device for broadcasting the second channel connection initiation signal can be lowered.

In some embodiments, after the second channel connection between the first device and the second device is disconnected, when the first device contacts the second device again, the second device can send the first signal including the first indication information. The first device can determine that the first device has previously established the second channel connection with the second device according to the first indication information. The first device may not need to broadcast the second channel connection initiation signal, but instead may obtain the locally stored encryption key. The encryption key can be received by the first device when the first device previously established the second channel connection with the second device. The first device can establish the second channel connection with the second device directly according to the encryption key. Thus, the process of exchanging the encryption keys with the second device can be reduced, the connection efficiency can be improved, and the power consumption of the first device can be lowered.

FIG. 2 illustrates a schematic flowchart of a first signal including second indication information according to some embodiments of the present disclosure. The process includes the following steps.

At S201, the first signal is determined to include second indication information. The second indication information indicates that the first device has not previously established a second channel connection with the second device. The second channel connection initiation signal is broadcasted to allow the second device to feed back the encryption key when receiving the second channel connection initiation signal.

If the first signal includes the second indication information, the second indication information can indicate that the first device has not previously established a second channel connection with the second device. This connection can be an initial connection.

When the first device and the second device establish the second channel connection for the first time, the first device can broadcast the second channel connection initiation signal. When receiving the second channel connection initiation signal, the second device can feed back the encryption key.

At S202, the encryption key fed back by the second device is received.

The second channel connection initiation signal can carry the address information of the first device.

After receiving the second channel connection initiation signal, the second device can obtain the encryption key and feed the encryption key back to the first device through the address information carried in the second channel connection initiation signal.

At S203, the second channel connection is established with the second device based on the encryption key.

Correspondingly, the first device can receive the encryption key fed back by the second device and initiate the pairing process to establish the second channel connection between the first device and the second device.

In some embodiments, after receiving the encryption key, the first device can also send the encryption key to the second device to realize the pairing process to enhance the data transmission security between the first device and the second device.

After the first device establishes the second channel connection with the second device, the first device can also store the encryption key fed back by the second device to provide the foundation for subsequent reconnections between the first device and the second device.

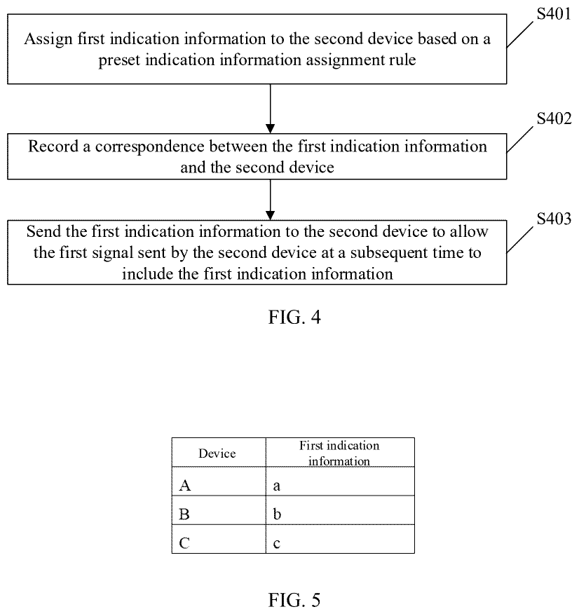

After the first device and the second device establish the second channel connection for the first time, to facilitate subsequent fast reconnections, the first indication information indicating the second device may need to be agreed on. FIG. 4 illustrates a schematic flowchart of a first device and a second device agreeing on the first indication information according to some embodiments of the present disclosure.

In some embodiments, when the first signal sent by the second device includes the second indication information, the first device can be determined to have not previously established a second channel connection with the second device. The first device can broadcast the second channel connection initiation signal. After receiving the second channel connection initiation signal, the second device can feed back the encryption key. After receiving the encryption key, the first device can establish the second channel connection with the second device based on the encryption key. Thus, the process for the first device and the second device to establish the second channel connection for the first can be realized.

In embodiments of the present disclosure, after receiving the first signal sent by the second device based on the first channel, the method further includes, based on the first device having already established a second channel connection with a third device, and determining that the first indication information included in the first signal does not match the third device, disconnecting the second channel connection established with the third device. The third device can receive the touch input operation of the first device, and the third channel and the second channel can have the same transmission protocol.

The third device and the second device can both receive the touch input operation from the first device.

In some embodiments, the second device and the third device can be the same type of device, such as a tablet computer, laptop, or another touch-input-enabled electronic device.

In some embodiments, the second device and the third device can also be different types of devices. For example, the second device can be a tablet computer, and the third device can be a touch-input-enabled laptop. The present disclosure does not limit the specific types of the second device and the third device.

For example, the first device can be a stylus equipped with Bluetooth, the second device can be a touch-input-enabled laptop with Bluetooth, and the third device can be a touch-input-enabled tablet computer with Bluetooth. In some other embodiments, the first device can be a stylus with a WiFi connection function, and the second and third devices can be tablet computers with WiFi.

The third device and the first device can have already established a second channel connection. When the first device performs a touch input operation on the second device, the first device may not be disconnected from the third device.

The second device can generate the first signal based on the touch input operation of the first device and transmit the first signal to the first device via the first channel. The first device can determine that the first signal includes the first indication information. However, the device indicated by the first indication information may not be the third device. Then, the first device can be first disconnected from the second channel connection with the third device, and then establish a second channel connection with the second device. After the first device is disconnected from the third device, steps S102 and S103 in FIG. 1 are executed.

FIG. 3 illustrates a schematic diagram showing an application scenario of a method for connecting devices according to some embodiments of the present disclosure. The application scenario includes the first device, the second device, and the third device. In the application scenario, the first device can be a stylus 301, and the second device and the third device can be tablet computers 302 and 303. The stylus can be connected to the two tablet computers through Bluetooth connections. The stylus 301 can be connected to the tablet computer 303 via Bluetooth. When the stylus 301 performs a touch input operation on the touchscreen of the tablet computer 302, the tablet computer 302 can send a mask signal carrying the first indication information to the stylus 301 through a mask channel. The stylus 301 can analyze the mask signal and determine that the stylus is currently in contact with the tablet computer 302. Then, the stylus 301 can be disconnected from the Bluetooth connection with the tablet computer 303 and obtain the locally stored encryption key of the tablet computer 302. The stylus 301 can be connected to the tablet computer 302 through the Bluetooth connection according to the encryption key. The dashed line in FIG. 3 represents the Bluetooth connection.

In some embodiments, the first device can have already established a second channel connection with the third device. After receiving the first signal sent by the second device, if the first indication information in the first signal does not match the third device, it is determined that the first device does not perform the touch input operation on the third device. Then, the first device can be disconnected from the second channel connection with the third device, and the first device can then establish a second channel connection with the second device. Thus, the first device can be connected to a plurality of devices through the second channel connection, can only be connected to one device, and can quickly switch the connected device.

FIG. 4 illustrates a schematic flowchart of the first device and the second device agreeing on the first indication information according to some embodiments of the present disclosure. The process includes the following steps.

At S401, the first indication information is assigned to the second device based on a preset indication information assignment rule.

In the preset indication information assignment rule, the first device can assign the first indication information to the second device according to the rule.

The first device can be connected to a plurality of devices capable of receiving and responding to the touch input operations of the first device. The first device can assign the first indication information to each device, which has previously established a second channel connection with the first device.

Each device can be assigned with the first indication information to distinguish different devices.

In some embodiments, a device identifier can be used as the first indication information. The identifier can be a Bluetooth MAC (Media Access Control) address of the device. In some other embodiments, specific information can be assigned to each device to distinguish the device from other devices.

In some embodiments, according to the number of devices previously connected to the first device, a sequence number can be assigned to the second device as the first indication information. In FIG. 5, the process of assigning the first indication information to the second device is described in detail.

Due to the message format limitation for the first signal sent by the second device to the first device, the first signal can carry limited data amount. The device identifier can occupy long characters. If many free positions exist in the first signal, the device identifier can be used as the first indication information. If a few free positions exist in the first signal, information with relatively few bits can be used as the first indication information.

At S402, the correspondence between the first indication information and the second device is recorded.

After assigning the first indication information to the second device, the correspondence between the first indication information and the second device can be recorded, which provides the basis for subsequently determining whether a second channel connection has been previously established with the second device according to the received first signal.

The first device can establish second channel connections with a plurality of devices. After the first device establishes a second communication connection with each device, the first indication information can be assigned to each device, and the correspondence between the devices and the first indication information can be recorded.

In some embodiments, the first device can include a table to record the correspondence. The table can record each second device and the corresponding first indication information. The second device can be recorded by the identifier.

FIG. 5 illustrates a schematic diagram of the correspondence according to some embodiments of the present disclosure. The diagram records three devices ABC. Device A corresponds to first indication information a, device B corresponds to first indication information b, and device C corresponds to first indication information c.

At S403, the first indication information is sent to the second device to cause the first signal sent by the second device at a later time to include the first indication information.

After assigning the first indication information to the second device, the first device can send the first indication information to the second device. The second device can store the first indication information.

When the touch input operation is performed on the second device again, the second device can generate the first signal according to the first indication information and send the first signal to the first device.

In some scenarios, if the second device has only established the second channel connection with the first device, the second device can only store the first indication information assigned by the first device.

In some scenarios, if the second device has established connections with a plurality of input devices capable of performing touch input operations, the second device can only store the first indication information of the device that is lastly connected to the second device through the second channel.

In some embodiments, the first device can send the first indication information to the operating system (OS) of the second device. The OS of the second device can then transmit the first indication information to the touchscreen. The touch screen can store the first indication information.

In some embodiments, after the first device and the second device establish the second channel connection for the first time, the first device can assign the first indication information to the second device, record the correspondence between the first indication information and the second device, and send the first indication information to the second device. The second device can record the first indication information. When the second device sends the first signal, the first signal can include the first indication information to indicate that the first device has previously established the second channel connection with the second device.

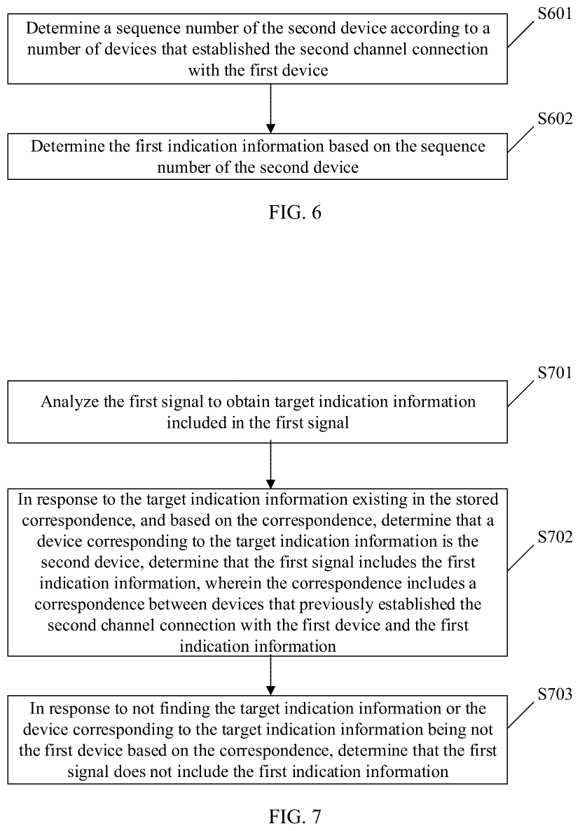

FIG. 6 illustrates a schematic flowchart of assigning first indication information to a second device based on a predetermined indication information assignment rule according to some embodiments of the present disclosure. The process can include the following steps.

At S601, according to the number of devices that have established the second channel connections with the first device, the sequence number of the second device is determined.

Since the identifier of the second device is typically long, and the message format of the first signal sent by the second device to the first device is limited, the first indication information occupying fewer bits can be assigned to the second device.

In some embodiments, according to the number of devices that have established the second channel connections with the first device, the sequence number of the second device can be determined.

For example, the first device can have established the second channel connection with two devices. When the currently connected second device is the second of the two devices that have established the second channel connections with the first device, the sequence number of the currently connected second device can be determined to be 2.

For example, the first device may have established the second channel connections with 10 devices. When the currently connected device is the tenth of the 10 devices that have established the second channel connections with the first device, the sequence number of the currently connected second device can be determined to be 10.

In some embodiments, the sequence number of the second device can be used as a code.

At S602, the first indication information is determined based on the sequence number of the second device.

The sequence number of the second device can be determined according to the above steps. Corresponding to a position that is pre-reserved for the first signal in the first indication information, the first indication information can be determined.

The sequence number can be converted into a binary code. The binary code corresponding to the sequence can be written into the position that is pre-reserved in the first indication information.

In some embodiments, if the binary code converted from the sequence number of the second device requires more bits than the reserved position in the first indication information, the sequence number of the second device can be converted to obtain a binary code that fits within the reserved position.

In some embodiments, 3 bits can be reserved in the first signal for transmitting the first indication information. Correspondingly, the data can be transmitted can be decimal values 0-7 (a total of 8 numbers).

0 can be set as non-existent by default. The second indication information can correspond to 0.

When the sequence number of the second device is between 1 and 7, the value of the sequence number can be converted into a binary code, which can be used as the first indication information.

To reduce complexity in the binary conversion process, a cyclic sequence queue can be set to cyclically use 7 sequence numbers of 1-7.

If the sequence number of the second device is greater than 7, the remainder after dividing the sequence number by 7 can be converted into binary code, which can be used as the first indication information for the second device.

For example, if the sequence number of the second device is 2, 2 can be converted to binary cold 010, which can be added to the first signal as the first indication information for the second device.

For another example, if the sequence number of the second device is 11, 11 can be divided by 7 to obtain a remainder of 4.4 can be converted into binary code 100, which can be added to the first signal as the first indication information for the second device.

In some embodiments, the sequence number of the currently connected second device can be determined according to the number of devices that have previously established a second channel connection with the first device. The first indication information for the second device can be then determined based on the sequence number. Since the bits required for transmitting the sequence number is far fewer than bits required by the identifier of the second device, the data amount for transmitting the first indication information of the second device can be reduced.

FIG. 7 illustrates a schematic flowchart of determining whether the first signal includes the first indication information according to some embodiments of the present disclosure. The process includes the following steps.

At S701, the first signal is analyzed to obtain the target indication information included in the first signal.

After receiving the first signal, the first device can analyze the first signal to obtain the target indication information included in the first signal.

The target indication information can be the information carried in the reserved position for transmitting the indication information in the first signal.

The defined signal can be analyzed to obtain the target indication information included in the reserved position for the indication information in the first signal.

For example, the obtained target indication information can include numbers such as 0, 1, or 5.

Whether the target indication information exists in the correspondence locally stored in the first device can be determined, and whether the device corresponding to the target indication information is the second device can be determined to obtain a determination result. The subsequent step S702 or step S703 can be performed according to different determination results.

At S702, if the target indication information exists in the stored correspondence, and the device corresponding to the target indication information is determined to be the second device based on the correspondence, the first signal is determined to include the first indication information. The correspondence includes the correspondence between the device that has established the second channel connection with the first device and the first indication information.

The first device can store the correspondence. The correspondence can be used to record the devices that have established the second channel connection with the first device and the corresponding first indication information.

If the target indication information is found in the correspondence, and the device corresponding to the target indication information is determined to be the second device based on the correspondence, the first signal can be determined to include the first indication information. The first indication information can represent that the first device has established the second channel connection with the second device.

The correspondence can be generated and stored according to the first indication information agreed by the first device and the second device in FIG. 4.

In some embodiments, after the first device parses and obtains the target indication information, whether the target indication information is in a state of establishing a second communication connection can be determined. In some embodiments, whether the sequence number (code) corresponding to the target indication information is in the state of establishing the second communication connection can be determined. If yes, the code can be the code of the device that is currently in the second communication connection. Then, the target indication information can be determined as the first indication information. If the sequence number (code) corresponding to the target indication information is not in the state of establishing the second communication connection, whether the code is recorded in the correspondence can be determined. If the code is recorded in the correspondence, the target indication information can belong to the first indication information.

For example, the second communication connection can be a Bluetooth connection. When the two devices establish a Bluetooth connection, the first device can obtain the device information of the currently connected device via the Bluetooth function module, and then be compared with the device corresponding to the target indication information determined according to the connected device information. If the two devices match, the target indication information can be determined to be the first indication information.

At S703, if the target indication information is not found or the device corresponding to the target indication information is not the first device based on the correspondence, the first signal can be determined to not include the first indication information.

If the target indication information is not found in the correspondence, the first signal can be determined to not include the first indication information. The target indication information can be used as second indication information.

In some embodiments, if the second device does not store the first indication information, the default information can be added to the first signal when the second device generates the first signal. The default information may not exist in the correspondence.

For example, if the first indication information assigned by the first device to the second device is the sequence number of the device that establishes the second channel connection, and since sequence number 0 does not exist, the default information can be set to 0.

For example, if the target indication information is 000, and the correspondence of the first device may not include the indication information with sequence number 0, then the target indication information cannot be found in the indication information-to-device correspondence relationship, and it is determined that the target indication information is not the first indication information. The first signal does not include the first indication information.

In some embodiments, after the first device parses and obtains the target indication information, the first device can first determine whether the device corresponding to the target indication information matches the device currently establishing the second communication connection with the first device can be determined. If not, the first device can be disconnected from the device currently establishing the second communication connection with the first device.

In some embodiments, after parsing the target indication information, the first device can first determine whether the target indication information is in the state of establishing the second communication connection. In some embodiments, whether the sequence number (code) corresponding to the target indication information is in the state of establishing the second communication connection can be determined. If the target indication information is not in the state of establishing the second communication connection, the code may not be recorded in the correspondence, and the target indication information can be the second indication information.

If the target indication information is found in the correspondence, but the device corresponding to the target indication information is not the first device, and the second device has been connected to other devices capable of performing the touch input operation, the indication information of the other devices can be added to the first signal and sent to the first device. The indication information in the first signal may not be the first indication information.

In some embodiments, the first signal sent from the second device can be analyzed to obtain the target indication information included in the first signal. If the target indication information exists in the correspondence stored in the first device, and the corresponding device is determined to be the second device based on the correspondence, the first signal can be determined to include the indication information. The correspondence can include the correspondence between the devices that have established the second channel connection with the first device and the first indication information. If the target indication information is not found based on the correspondence, or the device corresponding to the identified target indication information is not the first device, the first signal can be determined to not include the first indication information. Thus, whether the first signal includes the first indication information can be determined based on the correspondence stored in the first device, and only simple information can be stored in the first device to realize the present solution.

Corresponding to the method for connecting devices applied to the first device of embodiments of the present disclosure, the present disclosure can further provide a method for connecting devices applied to the second device.

FIG. 8 illustrates a schematic flowchart of another method for connecting devices according to some embodiments of the present disclosure. The method can be applied to an electronic device that is used as the second device. The second device can receive and respond to a touch input operation performed by the first device. The method includes the following steps.

At S801, based on the received touch input operation of the first device, the first signal is generated according to the first indication information. The first indication information indicates that the first device has previously established a second channel connection with the second device.

The first device can be used as the input device for the touch input operation and can perform the touch input operation on the second device. The second device can receive and respond to the touch input operation performed by the first device.

In some embodiments, the first device can be a stylus, and the second device can be a touchpad.

When the first device performs a touch input operation in the touch input area of the second device, the second device can generate the first signal and send the first signal to the first device.

In some embodiments, the first signal can be a mask signal. The first channel can be a transmission channel for the mask signal, configured to transmit the mask signal.

Generating the first signal according to the first indication information can include, based on the second device storing the first indication information, generating the first signal according to the first indication information. The first indication information is generated when the first device establishes the second channel connection with the second device through an encryption key and fed back to the second device.

When the first device and the second device establish the second channel connection via the encryption key, the first device can generate and send the first indication information to the second device. The second device can store the first indication information.

When the second device generates the first signal, the first signal can carry the first indication information.

The second device may have previously established a second communication connection with the first device. The touch screen of the second device can store the first indication information.

The touch screen of the second device can generate an uplink mask signal. When generating the uplink mask signal, the first indication information stored in the touch screen can be written into the uplink mask signal. Thus, when the uplink mask signal is sent, the first indication information can be sent to the first device.

In some embodiments, if the second device does not store the first indication information, the first signal can be generated according to the second indication information, which is described in detail in subsequent embodiments.

At S802, the first signal is transmitted to the first device through the first channel to cause the first device to prohibit broadcasting the second channel connection initiation signal based on the first indication information in the first signal. The second channel and the first channel have different transmission protocols.

The first channel can be a mask channel configured to transmit the mask signal.

The second device can transmit the first signal generated to the first device through the first channel.

After receiving the first signal, the first device can determine that the second device has previously established the second channel connection with the first device based on the first indication information. Then, the first device can prohibit broadcasting the second channel connection initiation signal.

The second channel can adopt a Bluetooth transmission protocol or a Wi-Fi transmission protocol, etc.

At S803, the connection request information for establishing the second channel connection sent by the first device is received. The connection request information is generated based on the encryption key stored locally in the first device.

The first device can determine that the second device has previously established a second channel connection with the first device, and directly establish the second channel connection with the second device based on the locally stored encryption key. The encryption key can be received by the first device from the second device when the second channel connection was previously established.

The first device can directly generate the connection request information based on the local encryption key, without exchanging encryption keys with the second device, and send the connection request information to the second device.

At S804, the second channel connection with the first device is established based on the connection request information.

After receiving the connection request information, the second device can establish the second channel connection with the first device based on the connection request information, without exchanging the encryption keys with the first device.

In some embodiments, after the second channel connection between the second device and the first device is disconnected, when the first device contacts the second device again, the second device can send the first signal including the first indication information. The first device can determine that the first device has previously established a second channel connection with the second device according to the first indication information and may not broadcast the second channel connection initiation signal but obtain the locally stored encryption key. The encryption key can be received when the first device previously established the second channel connection with the second device. The connection request information can be directly generated according to the encryption key and sent to the second device. The second device can directly establish the second channel connection with the first device according to the connection request information. Thus, the encryption key exchange process with the second device can be reduced, the connection efficiency can be improved, and the power consumption of the first device can be lowered.

Embodiments of the present disclosure can further provide a process of generating the first signal when the second device does not store the first indication information. The process can include, if the second device does not store the first indication information, based on the received touch input operation of the first device, generating the first signal according to the second indication information. The second indication information can indicate that the first device does not establish a second channel connection with the second device.

Each device by default has second indication information. The second indication information can indicate that the device has not established a second channel connection with the first device.

For the specific form of the second indication information, reference can be made to the process of assigning the first indication information to the second device in FIG. 6.

The second indication information is different from the first indication information. When the first device assigns indication information to the second device, the first device may not use the second indication information.

When the second device does not store the first indication information, when receiving the touch input operation of the first device, the second device can generate the first signal according to second indication information to allow the first device to determine that the first device has not established a second channel connection with the second device according to the second indication information in the first signal.

In some embodiments, if the second device stores the first indication information, when receiving the touch input operation of the first device, the second device can generate the first signal according to the second indication information that represents that the first device has not established a second channel connection with the second device to allow the first device to determine that the first device has not established a second channel connection with the second device according to the first signal.

Corresponding to the method for connecting devices of embodiments of the present disclosure, the present disclosure further provides a system applying the method for connecting devices.

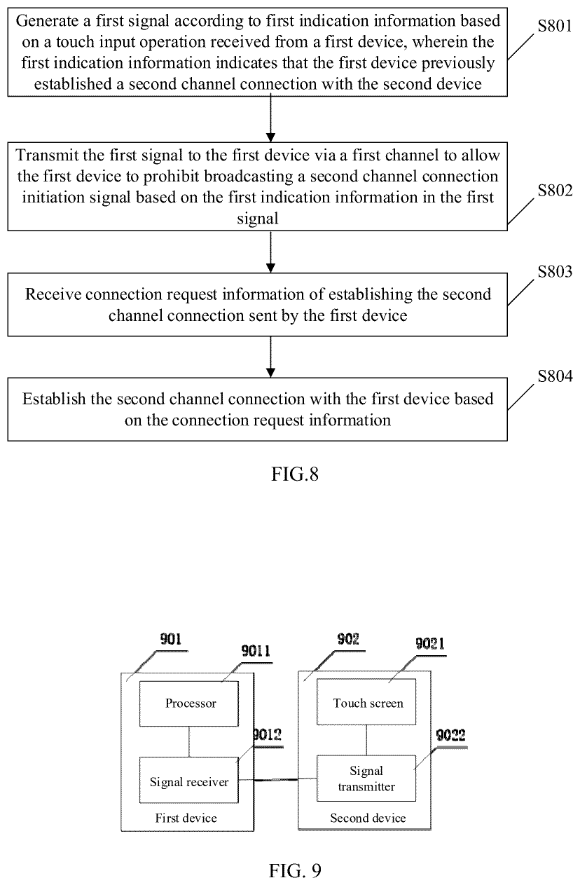

FIG. 9 illustrates a schematic structural diagram of a device connection system according to some embodiments of the present disclosure. The system includes the following structures, including the first device 901 and the second device 902.

The first device 901 includes a processor 9011 and a signal receiver 9012.

The second device 902 includes a touch screen 9021 and a signal transmitter 9022.

When the touch screen of the second device receives the touch input operation of the first device, the touch screen of the second device can generate the first signal according to the first indication information. The first indication information can indicate that the first device previously established a second channel connection with the second device. The signal transmitter can be configured to transmit the first signal to the first device through the first channel.

The signal receiver of the first device can be configured to receive the first signal. The processor of the first device can determine that the first signal includes the first indication information, and prohibit broadcasting the second channel connection initiation signal. The first device can establish a second channel connection with the second device based on the locally stored encryption key. The encryption key can be received from the first device when the first device previously established the second channel connection with the second device. The second channel and the first channel can have different transmission protocols.

For the function of structures of the first device and the second device of embodiments of the present disclosure, reference can be made to the description of method embodiments above, which is not repeated here.

In some embodiments, after the second channel connection between the first device and the second device is disconnected, when the first device contacts the second device again, the second device can send the first signal including the first indication information, may not broadcast the second channel connection initiation signal, can obtain the locally stored encryption key. The encryption key can be received from the second device when the first device previously established the second channel connection with the second device. The first device can directly establish a second channel connection with the second device according to the encryption key. The process of exchanging the encryption keys between the first device and the second device can be reduced, the connection efficiency can be improved, and the power consumption of the first device can be lowered.

Corresponding to the method for connecting devices of embodiments of the present disclosure, the present disclosure further provides an electronic device, a computer-readable storage medium, and a computer program product corresponding to the method for connecting devices.

The electronic device can include a delay circuit.

The electronic device can include a memory and a processor.

The memory can store a processing program.

The processor can be configured to load and execute the processing program stored in the memory to implement the steps of any of the method for connecting devices described above.

For the specific method for connecting devices of the electronic device, reference can be made to the method for connecting devices embodiments above.

The computer-readable medium stores a computer program. The computer program can be called and performed by the processor to realize the steps of any of the method for connecting devices above.

For the computer program stored in the computer-readable storage medium implementing the method for connecting devices, reference can be made to the method for connecting devices embodiments above.

The computer program product can include a computer program/command. The computer program/command can be performed by the processor to realize the steps of any of the method for connecting devices above.

For the method for connecting devices realized by performing the computer program product, reference can be made to the method for connecting devices embodiments above.

Various embodiments of the present disclosure are described in a progressive manner. Each embodiment focuses on the differences from other embodiments. The same or similar parts among the embodiments can be referenced to each other. For the apparatus of embodiments of the present disclosure, since the apparatus corresponds to the method of embodiments of the present disclosure, the description is relatively simple. For related parts, reference can be made to the method embodiments.

The above description of embodiments of the present disclosure can enable those skilled in the art to implement or use the present disclosure. Various modifications to these embodiments are apparent to those skilled in the art. The general principles defined here can be applied to other embodiments without departing from the spirit or scope of the present disclosure. Therefore, the present disclosure is not limited to embodiments of the present disclosure but is conformed to the widest scope consistent with the principles and novel features of the present disclosure.

What is claimed is:

1. A method for connecting devices, applied to a first device, comprising:
receiving a first signal sent by a second device via a first channel, wherein the first signal is generated by the second device based on a touch input operation of the first device;
determining that the first signal includes first indication information, and prohibiting broadcasting a second channel connection initiation signal, wherein the first indication information indicates that the first device previously established a second channel connection with the second device; and
establishing a second channel connection with the second device based on a stored locally encryption key, wherein the encryption key was received by the first device from the second device when the first device previously established the second channel connection with the second device, and the first channel and a second channel have different transmission protocols.

2. The method for connecting devices according to claim 1, further comprising:
determining that the first signal includes second indication information, wherein the second indication information indicates that the first device has not previously established the second channel connection with the second device, and broadcasting the second channel connection initiation signal to allow the second device to feed back an encryption key upon receiving the second channel connection initiation signal;
receiving the encryption key fed back by the second device; and
establishing the second channel connection with the second device based on the encryption key.

3. The method for connecting devices according to claim 1, further comprising, after receiving the first signal sent by the second device via the first channel:
based on the first device having already established a second channel connection with a third device, determining that the first indication information included in the first signal does not match the third device, and disconnecting the second channel connection established with the third device, wherein the third device is able to receive the touch input operation of the first device.

4. The method for connecting devices according to claim 2, further comprising, after establishing the second channel connection with the second device based on the encryption key:
assigning first indication information to the second device based on a preset indication information assignment rule;
recording a correspondence between the first indication information and the second device; and
sending the first indication information to the second device to allow the first signal sent by the second device at a subsequent time to include the first indication information.

5. The method for connecting devices according to claim 4, wherein assigning the first indication information to the second device based on the preset indication information allocation rule includes:
determining a sequence number of the second device according to a number of devices that established the second channel connection with the first device;
determining the first indication information based on the sequence number of the second device.

6. The method for connecting devices according to claim 1, wherein determining whether the first signal includes the first indication information includes:
analyzing the first signal to obtain target indication information included in the first signal;
in response to the target indication information existing in the stored correspondence, and based on the correspondence, determining that a device corresponding to the target indication information is the second device, determining that the first signal includes the first indication information, wherein the correspondence includes a correspondence between devices that previously established the second channel connection with the first device and the first indication information; and
in response to not finding the target indication information or the device corresponding to the target indication information being not the first device based on the correspondence, determining that the first signal does not include the first indication information.

7. A method for connecting devices, applied to a second device, comprising:
generating a first signal according to first indication information based on a touch input operation received from a first device, wherein the first indication information indicates that the first device previously established a second channel connection with the second device;
transmitting the first signal to the first device via a first channel to allow the first device to prohibit broadcasting a second channel connection initiation signal based on the first indication information in the first signal;
receiving connection request information of establishing the second channel connection sent by the first device; and
establishing the second channel connection with the first device based on the connection request information;
wherein the connection request information is generated by the first device based on a locally stored encryption key, and the first channel and a second channel have different transmission protocols.

8. The method for connecting devices according to claim 7, wherein generating the first signal according to the first indication information includes:
generating the first signal according to the first indication information based on the second device storing the first indication information, wherein the first indication information is generated when the first device and the second device establish the second channel connection through the encryption key and is fed back to the second device.

9. The method for connecting devices according to claim 7, further comprising:
in response to the second device not storing the first indication information, generating the first signal according to second indication information based on the touch input operation received from the first device, wherein the second indication information indicates that the first device has not previously established the second channel connection with the second device.

10. A device connection system, comprising a first device and a second device, wherein:
the first device includes a processor and a signal receiver;
the second device includes a touch screen and a signal transmitter;
in response to the touch screen of the second device receiving a touch input operation from the first device, a first signal is generated based on first indication information, the first indication information indicates that the first device previously established a second channel connection with the second device, and the signal transmitter transmits the first signal to the first device via a first channel; and
the signal receiver of the first device receives the first signal, the processor of the first device determines that the first signal includes the first indication information, prohibits broadcasting a second channel connection initiation signal, and establishes the second channel connection with the second device based on a locally stored encryption key, the encryption key was received by the first device from the second device when the first device previously established the second channel connection with the second device, and the first channel and a second channel have different transmission protocols.

11. The device connection system according to claim 10, wherein the processor is further configured to:
determine that the first signal includes second indication information, wherein the second indication information indicates that the first device has not previously established the second channel connection with the second device, and broadcasting the second channel connection initiation signal to allow the second device to feed back an encryption key upon receiving the second channel connection initiation signal;
receive the encryption key fed back by the second device; and
establish the second channel connection with the second device based on the encryption key.

12. The device connection system according to claim 10, wherein the processor is further configured to:
based on the first device having already established a second channel connection with a third device, determine that the first indication information included in the first signal does not match the third device, and disconnect the second channel connection established with the third device, wherein the third device is able to receive the touch input operation of the first device.

13. The device connection system according to claim 11, wherein the processor is further configured to:
assign first indication information to the second device based on a preset indication information assignment rule;
record a correspondence between the first indication information and the second device; and
send the first indication information to the second device to allow the first signal sent by the second device at a subsequent time to include the first indication information.

14. The device connection system according to claim 13, wherein the processor is further configured to:
determine a sequence number of the second device according to a number of devices that established the second channel connection with the first device;
determine the first indication information based on the sequence number of the second device.

15. The device connection system according to claim 10, wherein the processor is further configured to:
analyze the first signal to obtain target indication information included in the first signal;
in response to the target indication information exist in the stored correspondence, and based on the correspondence, determine that a device corresponding to the target indication information is the second device, and determine that the first signal includes the first indication information, wherein the correspondence includes a correspondence between devices that previously established the second channel connection with the first device and the first indication information; and
in response to not finding the target indication information or the device corresponding to the target indication information being not the first device based on the correspondence, determine that the first signal does not include the first indication information.
